(19) United States
(12) Patent Application Publication
(10) Pub. No.: US 2007/0187992 A1
(43) Pub. Date: Aug. 16, 2007

(54) Extendable B-pillar for a convertible vehicle

(75) Inventor: Franz-Ulrich Brockhoff, Bramsche (DE)

Correspondence Address: MICHAEL BEST & FRIEDRICH, LLP, 100 E WISCONSIN AVENUE, Suite 3300, MILWAUKEE, WI, 53202, US

(73) Assignee: Wilhelm Karmann GmbH, Osnabruck (DE)

(21) Appl. No.: 11/705,080

(22) Filed: Feb. 9, 2007

(30) Foreign Application Priority Data
Feb. 10, 2006 (DE) 10 2006 006 126.8

(51) Int. Cl. B62D 25/04

(52) U.S. Cl. 296/193.06

(57) ABSTRACT

A B-pillar segment (24) for a convertible vehicle (10) comprises a stationary lower part (30) and an upper part (28) displaceable relative to the stationary part (28), wherein the upper part (28) is insertable into the lower part (30) when the side windows (18, 20) of the vehicle (10) are opened.

### CROSS-REFERENCE

Priority to German patent application no. 10 2006 006 126.8 filed Feb. 10, 2006 is claimed, the contents of which are incorporated herein in its entirety.

### TECHNICAL FIELD

The invention concerns a B-pillar for a convertible vehicle, in particular for a four-door convertible vehicle, which includes a portion that is displaceable in a generally vertical direction.

### BACKGROUND ART

For four-door convertible vehicles, it is desirable to lower the side windows of the vehicle into the side doors when the convertible top is opened. In particular, the side vehicle windows should be capable of being completely received or accommodated within the body of the front and/or rear door.

In order to realize such a movement of the vehicle window, which is mostly a combined translational movement (up-down or vertical movement) and rotational movement (about an axis substantially perpendicular to the window plane), it is known to design the B-pillar of the vehicle, i.e. the middle pillar or column disposed between the side windows, relatively narrow or thin, in particular in the upper part of the B-pillar above the waist line of the vehicle, so that this movement of the vehicle side windows, in particular the rotational movement, is made possible.

Such thin B-pillars can, however, not undertake a supporting function. That is, such known B-pillars can not contribute to the absorption of forces, e.g. during a rollover of the vehicle, and/or can not substantially stabilize a roof structure.

A supplemental middle pillar or column for a motor vehicle is known from DE 42 41 054 C2, in which the middle pillar is divided in the vertical direction approximately at the level of the waist line of the vehicle. This pillar is provided supplemental to a side window that overlaps it and is retracted during normal vehicle driving conditions, i.e. the part above the waistline of the vehicle is slidably inserted into the lower part. The supplemental pillar is extended only when a rollover or a similar event occurs, so that the pillar then contributes to the reinforcement of the roof portion of the vehicle construction. However, this known pillar does not undertake all functions undertaken by the B-pillar of conventional four-door convertible vehicles, such as e.g., serving as a hinge for the side doors. Moreover, it is not disposed between the side windows of the vehicle.

### SUMMARY OF THE INVENTION

It is an object of the present invention to provide a B-pillar segment for a convertible vehicle that on the one hand can undertake supporting functions, i.e. stability or strength-related requirements, and on the other hand, does not hinder the lowering of the side window of the convertible vehicle when opening the convertible top of the convertible vehicle. In particular, the lowering of the pane of the side window should be facilitated and a tolerance compensation of deviations from the ideal window pane size should be enabled.

This object is solved by a B-pillar segment according to the present teachings.

The concept underlying the present teachings is to make the B-pillar, which is disposed between the front and rear door of a four-door convertible vehicle, lowerable together with at least one of the side window panes of the convertible vehicle. For this purpose, sufficient space substantially in the window pane plane may be provided so that at least one of the side windows can perform a combined translational and rotational movement, when the upper part of the B-pillar is lowered. In this case, the vehicle side windows can be rotated and completely lowered into the side doors. This functionality is achieved substantially independent from the breadth of the upper part of the B-pillar.

According to particular design requirements and circumstances, the lowering movement of the upper part of the B-pillar segment, i.e. of the part substantially above the waist line of the vehicle, can begin simultaneously with, shortly before or shortly after the lowering movement of the side windows. Because the upper part of B-pillar can also be designed relatively wide, it can undertake supporting functions and, in particular, safety-relevant functions, e.g. during a rollover of the vehicle, for the supplemental support of the roof.

According to an advantageous embodiment of the present teachings, the length of the upper part of the B-pillar segment preferably corresponds to the segment or distance between the side window lower edges and the roof frame of the convertible vehicle, i.e. to the segment or length above the waist line of the vehicle. If necessary, this upper segment or length can be somewhat shorter than the lower part, so that the upper part of the B-pillar can be fully received or accommodated within the lower part of the B-pillar. This makes it possible that the upper part of the B-pillar will not be visible in the opened state of the convertible top of the convertible vehicle.

### BRIEF DESCRIPTION OF THE DRAWINGS

In the following, the invention will be described in an exemplary manner with the assistance of the appended figures, in which:

FIG. 1 shows a convertible vehicle having a representative B-pillar segment according to the present teachings with the convertible top in the closed position;

FIG. 2 shows the convertible vehicle of FIG. 1 with an opened convertible top;

FIGS. 3-7 show the lowering movement of the upper part of the B-pillar segment and the side window panes in various opening states; and

FIG. 8 is a cross-sectional view from above of the representative B-pillar of the convertible vehicle.

### DETAILED DESCRIPTION OF THE INVENTION

In one aspect of the present teachings, a B-pillar segment for a convertible vehicle preferably comprises a stationary lower part and an upper part that is displaceable relative to the stationary lower part. Preferably, the upper part is insertable, and more preferably is completely insertable, into the lower part at least when a side window of the vehicle is opened.

In another aspect of the present teachings, the upper part preferably has a length that corresponds to the segment or distance between the side window lower edges and the roof frame of the convertible vehicle. In addition or in the alternative, the B-pillar segment formed of the lower part and the upper part preferably has or is capable of performing a supporting function, e.g., a roof supporting function and/or a side window supporting function.

In another aspect of the present teachings, when it is not in the lowered state, the upper part of the B-pillar segment is preferably disposed between adjacent side windows of the convertible vehicle.

In another aspect of the present teachings, a convertible vehicle comprises one of the above-mentioned B-pillar segments. In such a convertible vehicle, front and/or rear side windows of the convertible vehicle are preferably lowerable into front and/or rear side doors, respectively, of the vehicle. More preferably, the front and/or rear side windows are lowerable into the side doors of the convertible vehicle by performing a combined translational movement and rotational movement in the plane of the respective window pane.

In another aspect of the present teachings, the lowering- and lifting-movement of the upper part of the B-pillar segment takes place synchronized with the lowering- and lifting movement, respectively, of at least one of the side windows.

Each of the additional features and teachings disclosed below may be utilized separately or in conjunction with other features and teachings to provide improved B-pillars and convertible vehicles and methods for designing and using such B-pillars and vehicles. Representative examples of the present invention, which examples utilize many of these additional features and teachings both separately and in conjunction, will now be described in further detail with reference to the attached drawings. This detailed description is merely intended to teach a person of skill in the art further details for practicing preferred aspects of the present teachings and is not intended to limit the scope of the invention. Moreover, combinations of features and steps disclosed in the following detail description may not be necessary to practice the invention in the broadest sense, and are instead taught merely to particularly describe representative examples of the invention.

Further, various features of the representative examples and the dependent claims may be combined in ways that are not specifically and explicitly enumerated in order to provide additional useful embodiments of the present teachings. All features disclosed in the description and/or the claims are intended to be disclosed separately and independently from each other for the purpose of original written disclosure, as well as for the purpose of restricting the claimed subject matter independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

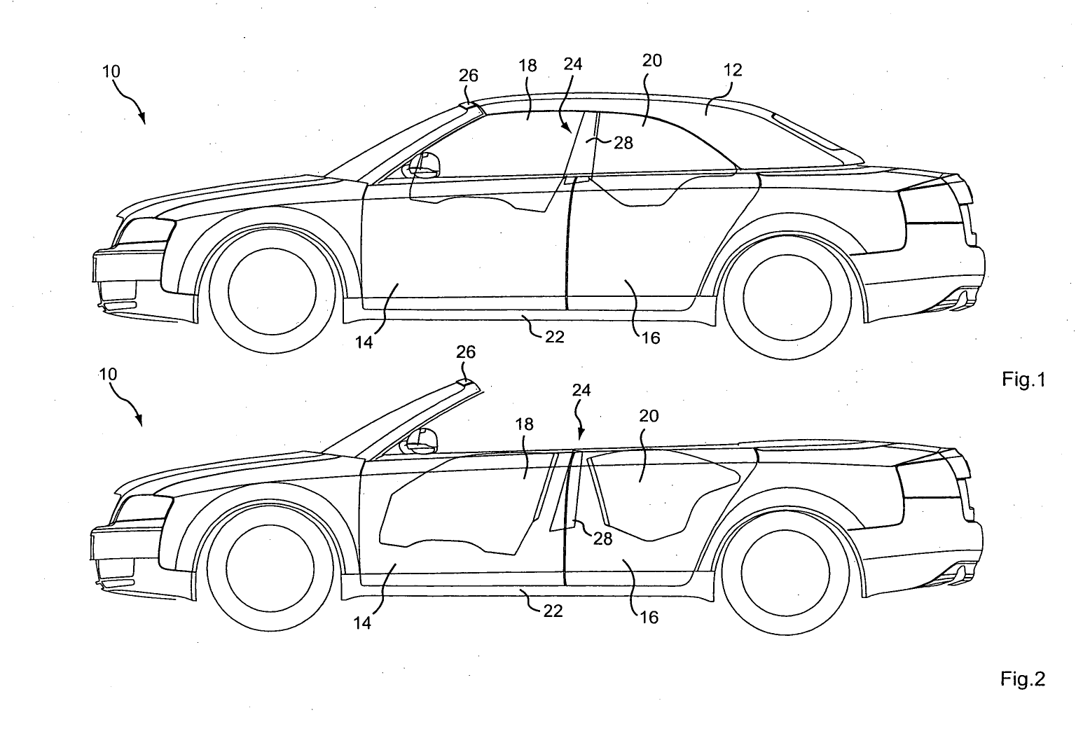

FIG. 1 shows a representative convertible vehicle 10 with a closed convertible top 12. The convertible vehicle 10 has four-doors and includes a front side door 14 and a rear side door 16. Of course, a front door 14 and a rear door 16 are likewise attached to the opposite side of the vehicle, which is not shown in FIGS. 1 and 2, so that the construction of the opposite side is essentially identical to the vehicle side visible in FIG. 1. The rear side door 16 is provided with a rear side window 20 and the front side door 14 is provided with a front side window 18.

A representative B-pillar of the convertible vehicle 10 extends between the front side door 14 and the rear side door 16 and between a vehicle floor 22 and the roof structure supporting the convertible top 12. The B-pillar segment 24 thus forms hinge points for the rear side door 16 as well as also the connection between the front side window 18 and the rear side window 20 in the closed state of the convertible top 12 and/or when the windows are rolled up, i.e. closed.

FIG. 2 shows the convertible vehicle of FIG. 1 with an opened convertible top 12 and opened side windows 18, 20. The convertible top 12, i.e. the roof portion between the windshield frame 26 and the rear portion of the vehicle, is storable in the rear portion of the vehicle. In the opened state of the convertible vehicle 10, the front side window 18 and the rear side window 20 may be completely received within the front door 14 and the rear door 16, respectively, so that they do not upwardly project over the waist line of the convertible vehicle 10. Moreover, an upper part 28 of the B-pillar 24 is insertable into a lower part 30 (not shown in FIG. 2) of the B-pillar 24, so that it likewise does not upwardly project over the waist line of the vehicle 10 when the convertible vehicle 10 is in its fully opened state.

As utilized herein, the term “waist line” is intended to refer to the respective upper surfaces of the side doors 14, 16 and the rear trunk of the convertible vehicle 10, which collectively define an upper surface of the vehicle body when the convertible top 10 is disposed in its closed (i.e. lowered or stored) position.

By comparing FIGS. 1 and 2, in particular the respective positions of the rear window 20, it can be seen that the rear side window is skewed or rotated in the plane of the window pane in a direction counter-clockwise relative to the starting position when the window was closed (FIG. 1). By at least partially rotating the rear side window pane during the lowering thereof, sufficient storage space within the vehicle rear door 16 can be provided for the lowered window pane without having to re-design the rear door 16. In a similar way, the front side window 18 can be skewed or rotated in the clockwise direction while the vehicle side window 18 is being lowered if sufficient storage space within the front door 14 is not already provided by the front door design for the front side window pane to be simply lowered in a linear manner. However, since the available space in the front door tends to be larger than in the rear door for many 4-door vehicle designs, a skewing or rotation in the window pane plane is often not required for the front side window 18, such that a purely (or substantially purely) translational lowering movement may suffice in this case.

In order to facilitate the movement of the side windows 18, 20 between the closed position shown in FIG. 2 and the opened position shown in FIG. 1, it is necessary that the B-pillar 24 does not hinder the rotational movement and/or avoids this rotational movement in the area of the upper part 28 of the B-pillar 24.

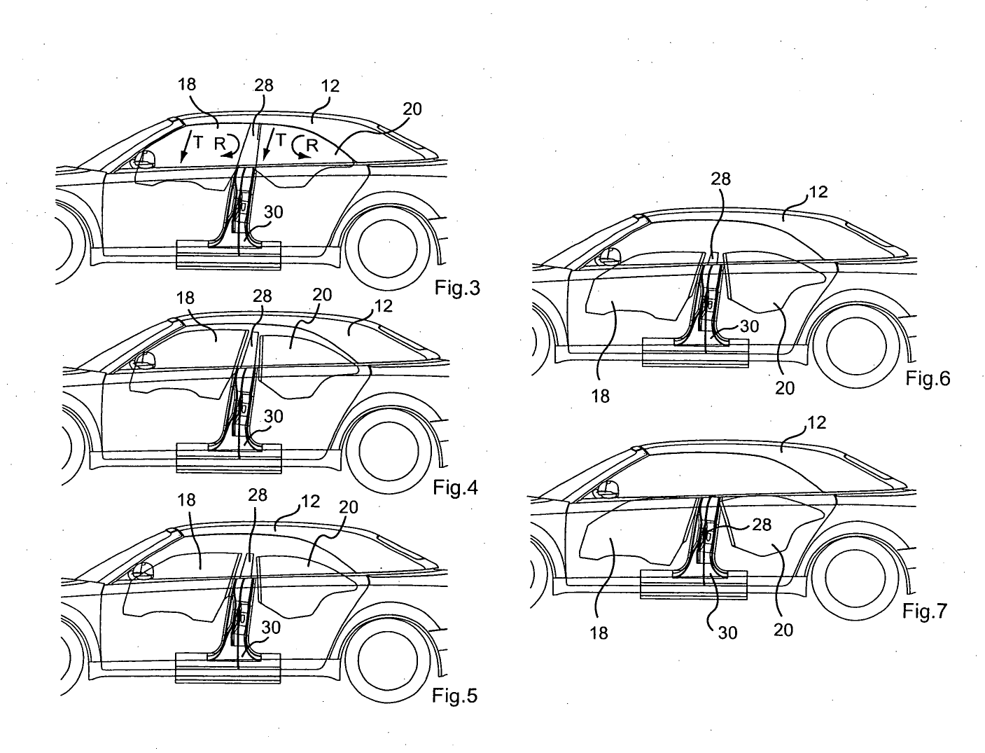

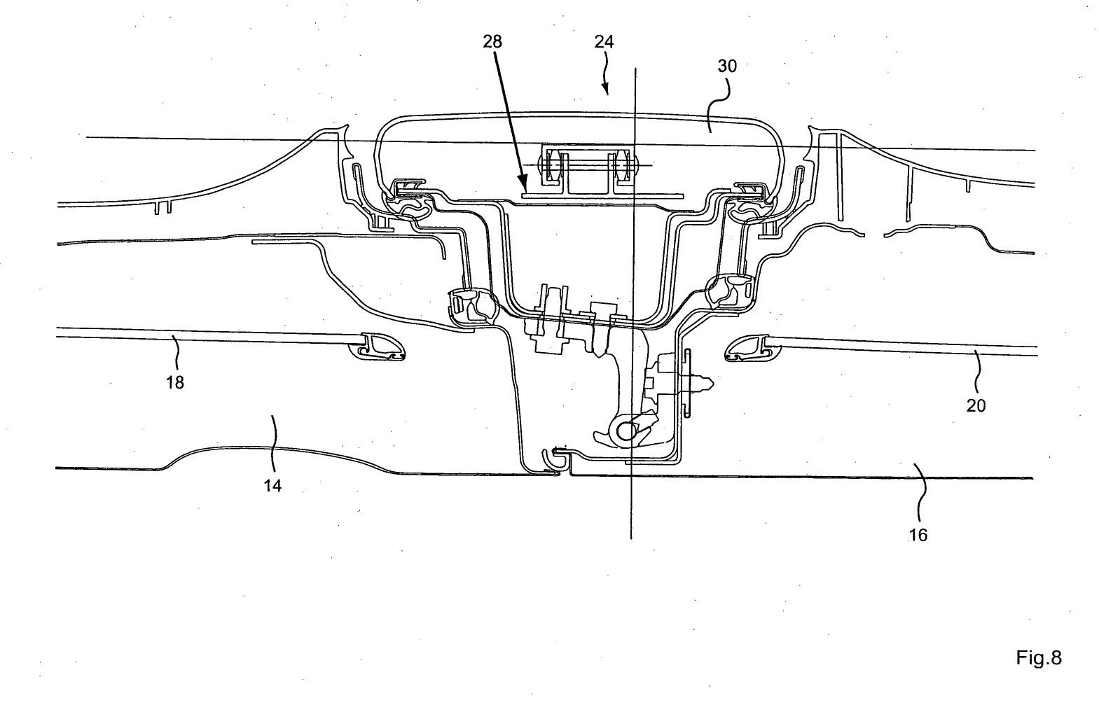

As can be understood from FIGS. 3-7, which show the opening movement of the side windows 18, 20 and their storage in the side doors 14, 16, the lowering movement (and a lifting movement when closing, respectively) of the upper part 28 of the B-pillar 24 is preferably synchronized with the movement of the side windows 18, 20, so that the upper part 28 of the B-pillar 24 is accommodated or received in the lower part 30 of the B-pillar 24. In order for the movement of the side windows 18, 20 and the upper part 28 of the B-pillar 24 to take place in a coordinated manner, the B-pillar 24 can be designed relatively large and without limitation with respect to its stability and load bearing capacity, so that it can contribute, e.g., to the absorption of forces acting on the roof and thus to support the roof. In FIGS. 3-7, the direction of the translational movement during opening of the vehicle side windows is identified with a “T” and the direction of the rotational movement during opening is identified with an “R”. During closing, the respective movement directions are reserved.

Of course, the opening movement of the side windows 18, 20 can also take place when the convertible top 12 is closed. It is thus advantageous for the front side window 18 to execute a purely (or substantially purely) translational movement and thus be accommodated or receivable in the body of the front side door 14 without lowering of the upper part 28 of the B-pillar 24, so that the upper part 28 of the B-pillar 24 can remain in the closed position (FIG. 1) when only the front side window 18 is opened (i.e. rolled down and stored within the front side door 14). Furthermore, because a rotational movement of the window in the plane of the window pane is required for the rear side window 20, the movement of the upper part 28 of the B-pillar 24 can be coupled to the movement of the rear side window 20.

Finally, FIG. 8 shows in a cross-sectional view how the upper part 28 of the B-pillar is accommodated or received in the lower part 30 of the B-pillar 24.

Naturally, the lowering and lifting of the upper part 28 of the B-pillar 24 with respect to the lower part 30 can be performed by a variety of mechanical and/or electric devices, such as mechanical, electrical and/or pneumatic actuators.

Furthermore, by disposing the upper part 28 between the adjacent side windows 18, 20, it is possible to compensate for variations from the ideal window pane size when the side windows 18, 20 are closed (i.e. rolled up to their upward-most position). The vertically-disposed edges of the upper part 28 and/or the side windows 18, 20 may be furnished with an elastic sealing material (e.g. rubber weather stripping or door trim), so that a sealed connection of the side windows 18, 20 to the upper part 28 is provided when the side windows 18, 20 and the upper part 28 are disposed in their upward-most position.

### REFERENCE NUMBER LIST

10 Convertible vehicle
12 Convertible top
14 Front side door
16 Rear side door
18 Front side window
20 Rear side window
22 Vehicle floor
24 B-pillar segment
26 Windshield frame
28 Upper part
30 Lower part

1. A B-pillar segment for a convertible vehicle, comprising:
a stationary lower part arranged and constructed to be fixedly attached to a vehicle body of the convertible vehicle, and
an upper part that is displaceable relative to the stationary lower part,
wherein the upper part is insertable into the lower part at least when a side window of the vehicle is opened.

2. A B-pillar segment according to claim 1, wherein the upper part has a length that substantially corresponds to the distance between a lower edge of the side window and a roof frame of the convertible vehicle.

3. A B-pillar segment according to claim 2, wherein the upper part is completely insertable in the lower part.

4. A B-pillar segment according to claim 3, wherein the B-pillar segment is arranged and constructed to perform a supporting function.

5. A B-pillar segment according to claim 4, wherein when it is not in its lowered state, the upper part of the B-pillar segment is arranged and constructed to be disposed between and to connect adjacent side windows of the convertible vehicle.

6. A convertible vehicle comprising a B-pillar segment according to claim 5 fixedly attached to a vehicle body substantially between front and rear side doors of the convertible vehicle.

7. A convertible vehicle according to claim 6, wherein front and/or rear side windows of the convertible vehicle are lowerable into the side doors of the convertible vehicle.

8. A convertible vehicle according to claim 7, wherein at least one of the front and rear side windows is lowerable into the respective side door by a combined translational movement and rotational movement in the plane of the window pane of the respective side window.

9. A convertible vehicle according to claim 8, wherein the upper part of the B-pillar segment is arranged and constructed to be lowered and raised in a manner synchronized with lowering and raising, respectively, of at least one of the side windows.

10. A convertible vehicle comprising:
a vehicle body,
a front side door and a rear side door disposed on one side of the vehicle body, each side door comprising a raisable and lowerable side window, and
an extendable B-pillar including:
a stationary lower part fixedly attached to the vehicle body substantially between the front side door and the rear side door and
an upper part that is displaceable relative to the stationary lower part, wherein the upper part is insertable into the lower part at least when at least one side window of the vehicle is opened.

11. A convertible vehicle according to claim 10, wherein the upper part has a length that substantially corresponds to the distance between an upper edge of the side doors and a roof frame of the convertible vehicle and the upper part is completely insertable in the lower part.

12. A convertible vehicle according to claim 11, wherein the B-pillar is arranged and constructed to support the roof frame when the upper part is displaced to an upward position relative to the lower part.

13. A convertible vehicle according to claim 12, wherein the upper part of the B-pillar is disposable between adjacent front and rear side windows of the convertible vehicle.

14. A convertible vehicle according to claim 13, wherein at least one of the front and rear side windows is arranged and constructed to be lowered into the respective side door by a combined translational movement and rotational movement substantially in the plane of the window pane of the side window.

15. A convertible vehicle according to claim 14, wherein the upper part of the B-pillar is arranged and constructed to be lowered and raised relative to the lower part of the B-pillar in a manner synchronized with lowering- and raising, respectively, of at least one of the side windows.

16. A convertible vehicle according to claim 15, wherein the stationary lower part of the B-pillar extends substantially between a floor of the convertible vehicle and the upper edge of the side doors, the stationary lower part providing at least one hinge point for attaching the rear side door.

17. A convertible vehicle according to claim 16, wherein when the upper part of the B-pillar is disposed in an upward-most position relative to the lower part and the front and rear side windows are disposed in upward-most position relative to the respective side doors, the upper part forms a connection between the front and rear side windows.

18. A convertible vehicle according to claim 17, wherein when the upper part of the B-pillar is disposed in the upward-most position relative to the lower part and the side windows are disposed in upward-most position relative to the respective side doors, the upper part forms a sealed connection between the front and rear side windows.

19. A convertible vehicle according to claim 18, wherein the front side window is arranged and constructed to be raised and lowered with substantially only a translational movement substantially within the plane of the front side window pane and the rear side window is arranged and constructed to be raised and lowered with a combined translational and rotational movement substantially within the plane of the rear side window pane.

20. A convertible vehicle according to claim 19, where the upper part of the B-pillar is arranged and constructed to be raised and lowered substantially with raising and lowering of the rear side window.
